(19) United States
(12) Patent Application Publication
(10) Pub. No.: US 2011/0009039 A1
(43) Pub. Date: Jan. 13, 2011

(54) METHOD AND APPARATUS FOR MANUFACTURING AN ABRASIVE WIRE

(75) Inventors: Venkata R. Balagani, Gilroy, CA (US); Mathijs Pieter Van Der Meer, Cheseaux-sur-Lausanne (CH)

Correspondence Address: PATTERSON & SHERIDAN, LLP - - APPM/TX, 3040 POST OAK BOULEVARD, SUITE 1500, HOUSTON, TX, 77056, US

(73) Assignee: APPLIED MATERIALS, INC., Santa Clara, CA (US)

(21) Appl. No.: 12/794,399

(22) Filed: Jun. 4, 2010

Related U.S. Application Data
(60) Provisional application No. 61/184,479, filed on Jun. 5, 2009.

(51) Int. Cl. B23D 61/18; B24D 11/00

(52) U.S. Cl. 451/533

(57) ABSTRACT

A method and apparatus for an abrasive laden wire is described. In one embodiment, an abrasive coated wire is described. The wire includes a core wire having a symmetrical pattern of abrasive particles coupled to an outer surface of the core wire, and a dielectric film covering portions of the core wire between the abrasive particles.

### CROSS-REFERENCE TO RELATED APPLICATIONS

This application claims benefit of U.S. Provisional Patent Application Ser. No. 61/184,479, filed Jun. 5, 2009, which is incorporated by reference herein.

### BACKGROUND OF THE INVENTION

1. Field of the Invention

Embodiments described herein relate to an abrasive coated wire. More specifically, to a method and apparatus for coating a wire with abrasives, such as diamonds or superhard materials.

2. Description of the Related Art

Wires having an abrasive coating or fixed abrasives located thereon have been adopted for precision cutting of silicon, quartz or sapphire ingots to make substrates used in the semiconductor, solar and light emitting diode industries. Other uses of the abrasive laden wire include cutting of rock or other materials.

One conventional method of manufacture includes an electroplating process to bond diamonds, diamond powder, or diamond dust to a core wire. However, the distribution of the diamonds on the core wire is purely random. The random distribution of diamonds on the wire creates challenges when using the wire in a precision cutting process.

Therefore, there is a need for a method and apparatus to produce an abrasive laden wire having a uniform concentration, density and size of diamonds on the wire.

### SUMMARY OF THE INVENTION

A method and apparatus to produce an abrasive laden wire having a uniform concentration, density and size of abrasives on the wire is described. In one embodiment, an abrasive coated wire is described. The wire includes a core wire having a symmetrical pattern of abrasive particles coupled to an outer surface of the core wire, and a dielectric film covering portions of the core wire between the abrasive particles.

In another embodiment, an abrasive coated wire is described. The wire includes a core wire made of a metallic material, and individual diamond particles of a substantially equal size coupled to an outer surface of the metallic material in a symmetrical pattern leaving portions of the metallic material exposed between adjacent diamond particles.

In another embodiment, an abrasive coated wire is described. The wire includes a core wire having a helical pattern of individual diamond particles coupled to an outer surface of the core wire, the diamond particles being a substantially equal size.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a schematic cross-sectional view of one embodiment of a plating apparatus.

FIG. 1B is an exploded cross-sectional view of a portion of a plated wire of FIG. 1A.

FIG. 2A is an exploded cross-sectional view of a core wire disposed in the plating tank of FIG. 1A.

FIGS. 2B and 2C are exploded cross-sectional views of one embodiment of a segmented perforated conduit.

FIGS. 3A-3D are side views of a portion of the perforated conduit showing embodiments of patterns of openings in the conduit that are utilized to pattern the core wire during a plating process.

FIG. 4A is a side view of a portion of a perforated conduit showing another embodiment of a pattern of openings.

FIG. 4B is a side view of a portion of a perforated conduit showing another embodiment of a pattern of openings.

FIG. 5A is a schematic cross-sectional view of another embodiment of a plating apparatus.

FIG. 5B is an exploded cross-sectional view of a portion of a pre-coated core wire of FIG. 5A.

FIGS. 6A-6D are side views of a portion of a plated wire showing embodiments of patterns of diamond particles formed on the core wire according to embodiments described herein.

FIGS. 7A and 7B are side views of a portion of a plated wire showing other embodiments of patterns of diamond particles formed on the core wire according to embodiments described herein.

FIG. 8 is a side view of a portion of a plated wire showing another embodiment of a pattern of diamond particles formed on the core wire according to embodiments described herein.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments described herein generally provide a method and apparatus for manufacturing an abrasive laden wire. The abrasive laden wire includes a substantially even distribution of diamond particles along a length thereof. Specific patterns of diamond particles on the wire may be produced. While the embodiments described herein are exemplarily described using diamonds as abrasive particles, other naturally occurring or synthesized abrasives may be used. For example, abrasives such as zirconia alumina, cubic boron nitride, rhenium diboride, aggregated diamond nanorods, ultrahard fullerites, and other superhard materials. The abrasives may be of uniform sizes, such as in a particle size classified form. Diamonds as used herein include synthetic or naturally occurring diamonds of a fine size, such as in a powder or dust.

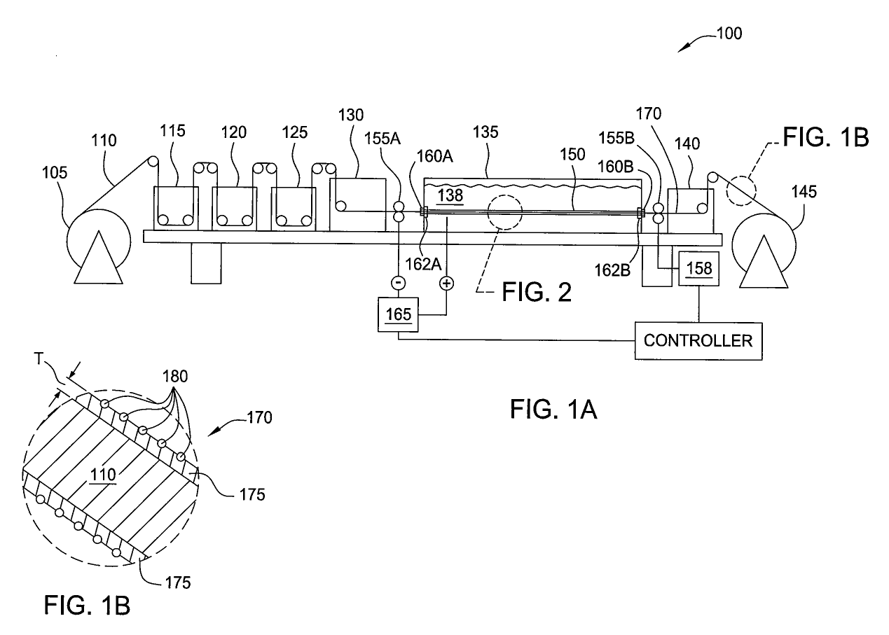

FIG. 1A is a schematic cross-sectional view of one embodiment of a plating apparatus 100 for manufacturing an abrasive coated wire. The plating apparatus 100 includes a feed roll 105 for dispensing a core wire 110. The core wire 110 may be routed by rollers through an alkaline cleaning tank 115, an acid tank 120, a rinse tank 125 and a pretreatment station or pretreatment device 130 prior to entering a plating tank 135. After the core wire 110 is plated, a plated wire 170 is routed through a post-treatment station or post-treatment device 140 and is wound on a take-up roll 145.

In one embodiment, the alkaline cleaning tank 115 contains a degreaser for cleaning the core wire 110 and the acid tank 120 includes an acid bath that neutralizes the alkaline treatment. The rinse tank 125 includes a spray or bath of water, such as deionized water. The pretreatment device 130 may comprise multiple treatment tanks and/or devices adapted to prepare the core wire 110 for plating. In one embodiment, the pretreatment device 130 includes a bath comprising a metal material, such as nickel or copper materials. In one specific embodiment, the pretreatment device 130 includes a bath comprising nickel sulfamate. The post-treatment device 140 is utilized to remove unwanted materials, coating residues and/or by-products from the plated wire 170. The post-treatment device 140 may comprise a tank containing a rinse solution, a tank containing an alkaline solution, a tank containing an acid solution, and combinations thereof.

The plating tank 135 includes a plating fluid 138 comprising a metal, such as nickel or copper, acid, a brightener and diamond particles. In one embodiment, the fluid includes nickel sulfamate, an acid, such as boric acid or nitric acid, and brighteners. The diamond particles are coated with a metal, such as nickel or copper prior to adding the particles to the fluid 138. The coating may include a thickness of about 0.1 μm to about 1.0 μm. The diamond particles are classified according to size to include a substantially homogeneous major dimension or diameter. In one embodiment, the diamond particles have a major dimension or diameter of about 15 μm to about 20 μm although other sizes may be used. The diamond particles may be in the form of a dust or powder and include the previously plated or deposited nickel coating, which is added to the fluid 138 in a predetermined amount. The temperature of the plating fluid 138 may be controlled to facilitate plating and/or minimize evaporation and crystallization. In one embodiment, the temperature of the plating fluid 138 is maintained between about 10° C. and about 60° C.

The core wire 110 includes any wire, ribbon or flexible material that is capable of being electroplated. Examples of the core wire 110 include high tensile strength metal wire, such as steel wire, a tungsten wire, a molybdenum wire, alloys thereof and combinations thereof. The dimensions or diameter of the core wire 110 can be selected to meet the shape and characteristics of the object to be cut. In one embodiment, the diameter of the core wire 110 is about 0.01 mm to about 0.5 mm.

In one embodiment, the core wire 110 is fed from the feed roll 105 through the tanks 115, 120 and 125, to the pretreatment device 130 and the plating tank 135. During the plating process, an electrical bias is applied to the core wire 110 and the fluid 138 from a power supply 165. In one embodiment, the core wire 110 is in communication with the power supply 165 by rollers 155A. The core wire 110 enters the plating tank 135 through a seal 160A and the plated wire 170 exits the plating tank 135 at a seal 160B. The seals 160A, 160B include an opening sized to receive the diameter of the core wire 110 and the plated wire 170, and are configured to contain the fluid 138 within the plating tank 135. The core wire 110 may be continuously or intermittently fed through the plating tank 135 by a motor 158 coupled to a drive roller device 155B. Alternatively or additionally, a motor (not shown) is coupled to the take-up roll 145. A controller is coupled to the motor 158 to provide speed and on/off control. The controller is also coupled to the power supply 165 to control electrical signals applied to the core wire 110 and the fluid 138.

FIG. 1B is an exploded cross-sectional view of a portion of the core wire 110 of FIG. 1A. The core wire 110 is shown having a coating 175 with embedded diamond particles 180 in a uniform pattern. The coating 175 may be a metallic layer, such as nickel or copper, which is bonded to the outer surface of the core wire 110 and diamond particles 180. In one embodiment, the coating 175 comprises a thickness T of about 0.005 mm to about 0.02 mm, depending on the size of the core wire 110 and/or the size of the diamond particles 180. In one embodiment, the thickness T of the coating 175 is minimized such that at least a portion of the diamond particles 180 are in contact with the core wire 110. In this embodiment, the overall diameter of the plated core wire 110 may be minimized in order to minimize the kerf during a cutting process.

In this embodiment, the pattern of diamond particles 180 is highly uniform in size and spacing, which is provided by feeding the core wire 110 into the plating tank 135 inside a perforated conduit 150 (FIG. 1A). The perforated conduit 150 is disposed in the plating tank 135 in a manner that controls the amount, size and distribution of diamond particles 180 that are plated on the core wire 110. The perforated conduit 150 may be a tube or pipe made of a dielectric material that is electrically isolated from the plating tank 135 and fluid 138 to prevent plating thereon. In one embodiment, the perforated conduit 150 is made from a mesh material that is permeable to cations, electrons and/or anions, such as an ionic membrane material. In this embodiment, the ionic membrane material may be a flexible material or a rigid material, or a flexible material that is braced or suspended by a frame or one or more support members in a manner that provides suitable rigidity. In another embodiment, the perforated conduit 150 is made by rolling a perforated plate into a tube. The perforated conduit 150 may be made of insulative materials, for example, plastic materials, such as polytetrafluoroethylene (PTFE) or other fluoropolymer and thermoplastic materials. In one embodiment, the perforated conduit 150 is made of a ceramic material or other hard, stable and insulative material. In another embodiment, the perforated conduit 150 is made from a sulfonated tetrafluoroethylene based fluoropolymer material, such as a NAFION® material.

The perforated conduit 150 includes a plurality of fine pores or openings to allow passage of diamond particles 180 of a predetermined size to pass through. In one embodiment, a plurality of openings are formed radially through an outer diameter or dimension to an inside diameter or dimension of the perforated conduit 150. Each of the openings may be formed by a machining process, such as drilling, electrostatic discharge machining, laser drilling, or other suitable method. In one embodiment, the perforated conduit 150 is formed in two or more pieces that are separatable or expandable to allow the conduit 150 to open or close about a perimeter of the core wire 110. In this manner, the inside diameter or inside dimension of the conduit 150 may be spaced away from the core wire 110 (and any coating 175 formed thereon) to allow the core wire 110 to move relative to the conduit 150 without contact between the core wire 110 (and/or coating 175) and the conduit 150. For example, the perforated conduit 150 may be split longitudinally into two or more pieces that may be separated and recoupled as desired. In another embodiment, the perforated conduit 150 is a consumable article that is replaced on an as-needed basis.

In one embodiment, the perforated conduit 150 is coupled to the plating tank 135 by at least one motion device 162A, 162B. In one embodiment, each of the motion devices 162A, 162B is a motor that provides rotational and/or linear movement to the perforated conduit 150. In one embodiment, the motion devices 162A, 162B are linear actuators, rotational actuators, transducers, vibrational devices, or combinations thereof. In one aspect, the motion devices 162A, 162B are adapted to rotate the perforated conduit 150 relative to the plating tank 135 in order to position the perforated conduit 150 relative to the core wire 110. As the diamond particles 180 and/or plating fluid 138 may tend to clog the fine pores or openings in the perforated conduit 150 during plating, the openings in the perforated conduit 150 may need to be cleared at regular intervals. In one aspect, the motion devices 162A, 162B are adapted to rotate the perforated conduit 150 relative to the plating tank 135 in order to spin the perforated conduit in a manner that clears the fine openings formed in the wall of the perforated conduit 150. In another aspect, the motion devices 162A, 162B are adapted to vibrate the perforated conduit 150 in order to clear the fine openings formed in the wall of the perforated conduit 150. For example, during the plating process, the fluid 138 passing through the openings formed through the wall of the perforated conduit 150 may clog one or more of the openings. The rotational and/or vibrational movement provided by the motion devices 162A, 162B frees the openings of any plating fluid and/or diamond particles that may be entrained therein.

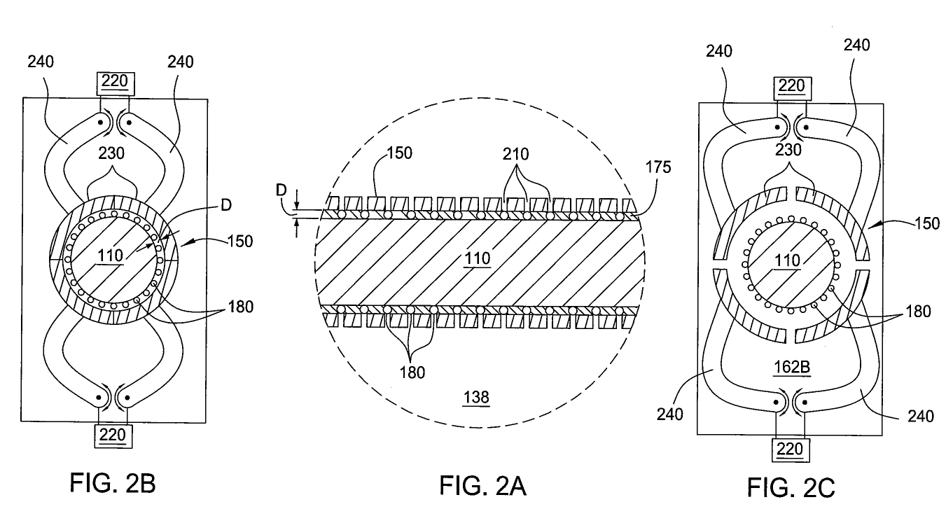

FIG. 2A is an exploded cross-sectional view of the core wire 110 disposed in the plating tank 135 of FIG. 1A. The perforated conduit 150 includes a plurality of openings 210, which in this embodiment, are equally sized and spaced. In this embodiment, each of the openings 210 includes a diameter that is slightly greater than a major dimension of the diamond particles 180. For example, if the diamond particle size in the fluid 138 is about 15 μm to about 20 μm, each opening 210 would include a diameter of about 22 μm to about 25 μm, which allows space for particles up to and including 20 μm and any plating fluid that may be adhered onto the particle. In this example, any particles greater than about 20 μm would not enter the openings 210 and plate to the core wire 110.

Likewise, the difference between the outer diameter of the core wire 110 and the inside diameter of the perforated conduit 150 is chosen to control the flow of fluid 138 and thus the density of diamond particles 180 plated onto the core wire 110. In one embodiment, a distance D is equal to or slightly less than the major dimension of the diamond particles 180 and/or slightly greater than a diameter or dimension of the core wire 110. For example, if the diamond particle size in the fluid is about 15 μm, the distance D would be about 15 μm to about 10 μm. In another example, if the diamond particle size is about 15 μm, the distance D would be about 7.5 μm to about 10 μm. The distance D provides a suitable flow of fluid 138 between the diamond particles 180 and permits a suitable layer of metal between the diamond particles 180 while preventing other diamond particles from plating between the openings 210. In one embodiment, the distance D is substantially equal to the thickness T (FIG. 1B).

In one embodiment, the core wire 110 is stopped and the power supply 165 is energized to perform a plating process. In this embodiment, the core wire 110 is tensioned sufficiently to maintain the distance D around the outer diameter thereof and along the length of the perforated conduit 150. As the core wire 110 is stopped in the plating fluid 138 and is electrically biased, the fluid 138 enters the openings 210 and diamond particles 180 are plated to the core wire 110 at positions adjacent the openings 210. The applied electrical bias may be continuous for a predetermined period, or cycled based on polarity inversions and/or on a temporal basis until a suitable concentration of fluid 138 has been exposed to the core wire 110. Diamond particles 180 contained in the plating fluid 138 are coupled to the core wire 110 at selected locations. Thus, a predetermined pattern of diamond particles 180 is formed on the core wire 110.

Once plating has been completed, the core wire is de-energized and new section of bare core wire 110 is advanced into the perforated conduit 150. The advancing procedure may be performed in a manner that prevents the previously plated diamond particles 180 from contact with the conduit 150. In one embodiment, the perforated conduit 150 is decoupled and/or spaced away from the plated wire 170 using an actuator. After the plated wire 170 is removed from the plating tank 135, the plated wire 170 is advanced through the post-treatment device 140 and to the take-up roll 145. The advancement process of the core wire 110 into the perforated conduit 150 may continue until a suitable length of plated wire is attained.

FIGS. 2B and 2C are exploded cross-sectional views of one embodiment of an actuator 220 and a segmented perforated conduit 150. In this embodiment, the perforated conduit 150 is provided in two or more segments 230 that are actuatable away from each other to allow the core wire 110 to move relative to the conduit 150 without contact between the particles 180 and the conduit 150. The perforated conduit 150 is shown in a closed position in FIG. 2B and in an open position in FIG. 2C. In one embodiment, the actuator 220 includes a plurality of arms 240 that are coupled to the segments 230. Each segment 230 may be moved by a respective arm 240 to separate the segments 230 while the core wire 110 is stationary. After the segments 230 are moved away from the core wire 110 and each other, the core wire 110 may be advanced without contact between the particles 180 and the conduit 150. The actuator 220 may be positioned within the plating tank 135 or coupled to the perforated conduit 150 from an exterior of the plating tank 135. In one embodiment, the actuator 220 may be utilized as one or both of the motion devices 162A, 162B of FIG. 1A.

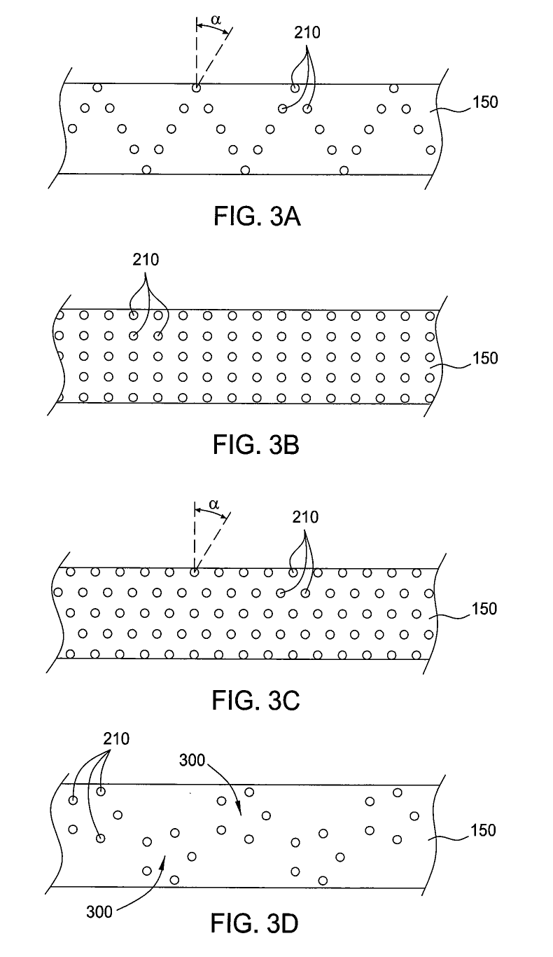

FIGS. 3A-3D are side views of a portion of the perforated conduit 150 showing embodiments of patterns of openings 210 that are utilized to pattern the core wire 110 during a plating process. FIG. 3A shows a zig-zag pattern, FIG. 3B shows a banded pattern and FIG. 3C shows a spiral pattern. The size of the openings 210 may be the same or different in any of these embodiments. The pitch and/or angle α may be varied or uniform between openings based on the desired pattern to be plated on the core wire 110. In one embodiment, each of the openings 210 in FIG. 3B form a screw-pitch or helix pattern similar to threads on a bolt or screw. In one aspect, the pitch between the openings 210 is not uniform or symmetrical between each opening 210 but each row of openings forms a thread-like pattern. In another aspect, the plurality of openings 210 form a double helix pattern that consists of rows of openings 210 spiraling in opposite directions.

FIG. 3D shows a uniform pattern of clusters 300 that consist of a plurality of openings 210. Each of the clusters 300 may be in a circular shape or a polygonal shape defined by the plurality of openings 210. In one embodiment, the clusters 300 are shaped as triangles, rectangles, trapezoids, hexagons, pentagons, octagons, nonagons, star shapes, and combinations thereof. The pitch and/or spacing (linearly or circumferentially) of the clusters 300 may be varied or uniform on the perforated conduit 150.

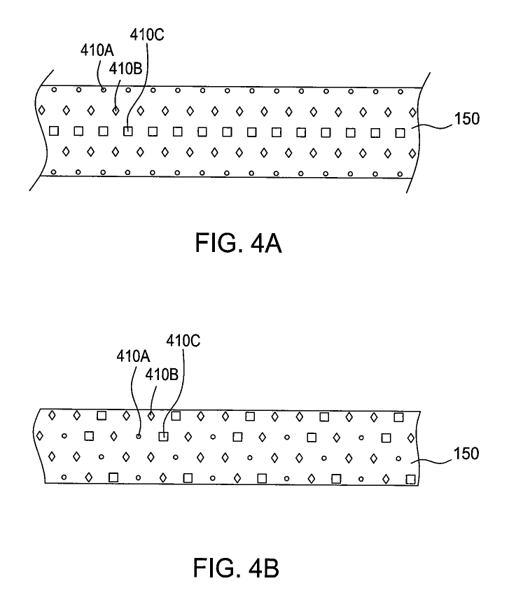

FIGS. 4A and 4B are side views of a portion of the perforated conduit 150 showing other embodiments of patterns of openings 210 that would be used to pattern the core wire 110 during a plating process. FIG. 4A shows a pattern of openings 410A, 410B and 410C in an arrow-like pattern. FIG. 4B shows a pattern of openings 410A, 410B and 410C in a spiraling arrow-like pattern. In each of these embodiments, the openings 410A, 410B and 410C are different sizes (i.e., diametrically) or shapes, which are adapted to receive diamond particles 180 of differing sizes and/or form shaped patterns on the core wire 110.

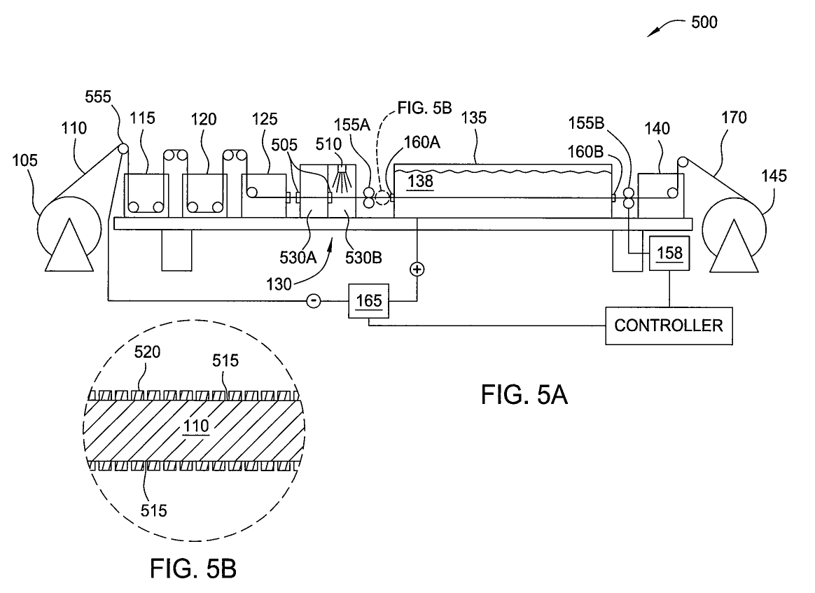

FIG. 5A is a schematic cross-sectional view of another embodiment of a plating apparatus 500 for manufacturing an abrasive coated wire. The plating apparatus 500 includes many elements that are similar to the elements described in FIG. 1A and will not be described further for brevity.

In this embodiment, the plating apparatus 500 includes a pretreatment device 130 that includes a pre-coating station 530A and a patterning station 530B. In one embodiment. The pre-coating station 530A is adapted to coat the core wire 110 with an insulative coating or dielectric film 520 that is resistant to the chemistry and/or temperatures of the plating fluid 138. The pre-coating station 530A may include a deposition apparatus, a tank or a spray device adapted to coat the surface of the core wire 110 with the dielectric film 520 that insulates the core wire 110 from the plating fluid 138. The dielectric film 520 includes materials that are non-reactive with the plating fluid 138. In one embodiment, the dielectric film 520 is light sensitive, such as a photoresist material. Examples include polymer materials, such as polytetrafluoroethylene (PTFE) or other fluoropolymer and thermoplastic materials that may be applied in a chemical vapor deposition (CVD) process, a physical vapor deposition (PVD) or other deposition process as well as a liquid form or an aerosol form to coat the core wire 110.

In one embodiment, the pre-coating station 530A is a vessel that contains a sealed processing volume to apply the dielectric film to the core wire 110. A vacuum pump (not shown) may be coupled to the pre-coating station 530A to apply negative pressure therein to facilitate a deposition process. Seals 505 are provided at the entry and exit points of the core wire 110. The seals 505 may be adapted to withstand and contain negative pressure and/or positive pressure, as well as provide a barrier to fluids while allowing the core wire 110 to pass therethrough.

After the dielectric film 520 has been applied to the core wire 110, the pre-coated wire is advanced to the patterning station 530B. The patterning station 530B is configured to remove portions of the dielectric film 520 applied to the core wire 110. In one embodiment, the patterning station 530B includes an energy source 510 adapted to apply energy, such as light, to the core wire 110 and dielectric film 520 that removes selected portions of the dielectric film 520 in a predetermined pattern. The energy source 510 may be a laser source, an electron beam emitter or charged-particle emitter adapted to impinge the core wire 110 and any coating formed thereon.

FIG. 5B is an exploded cross-sectional view of a portion of a pre-coated core wire 110 of FIG. 5A after patterning at the patterning station 530B. A plurality of voids 515 are formed by the patterning station 530B that are surrounded by islands of remaining dielectric film 520. Each of the voids 515 form a predetermined pattern consisting of exposed portions of the core wire 110 that may be plated while the islands of remaining dielectric film 520 shield the portions of the core wire 110 from plating.

Referring again to FIG. 5A, the energy source 510 of the patterning station 530B may be one or a plurality of light sources adapted to direct light to the circumference of the pre-coated core wire 110. In one embodiment, the energy source 510 is a laser device that is adapted to ablate portions of the dielectric film 520 according to a predetermined pattern. For example, the laser device may be coupled to an actuator that moves the laser source relative to the pre-coated core wire 110 and/or pulsed on and off according to instructions from the controller. In one embodiment, the laser device includes optics to shape a primary beam to form a desired spot or spots that impinge the dielectric film 520. In one aspect, the optics shape the primary beam into one or more secondary beams to form one or more spots having a diameter or dimension that is equal to or slightly greater than the major dimension of a diamond particle 180.

In another embodiment, the energy source 510 is a light source adapted to apply ultraviolet (UV) light to the circumference of the pre-coated core wire 110. In this embodiment, the dielectric film 520 is sensitive to UV light and a patterning mask is used to shield specific portions of the pre-coated core wire 110. The patterning mask may be in the form of a tube or conduit that surrounds the pre-coated core wire 110. Openings are provided in the patterning mask to expose UV light to the pre-coated core wire 110 in a specific pattern and remove selected portions of the dielectric film 520. The openings are configured to allow the UV light to strike the dielectric film 520 and create a void having a diameter or dimension that is equal to or slightly greater than the major dimension of a diamond particle 180. The pre-coated core wire 110 may be continuously or intermittently advanced during the ablation process and/or the photolithography process.

After the pre-coated core wire 110 is patterned to expose portions of the outer surface, the pre-coated core wire 110 is advanced to the plating tank 135. An electrical bias is applied to the core wire 110 and the fluid 138 from a power supply 165 to plate the exposed portions of the core wire 110. As the core wire 110 is pre-coated as described above, electrical continuity between the core wire 110 may be minimized or prevented by the dielectric film 520 remaining thereon. Therefore, electrical signals to the core wire 110 are applied at locations where the outer surface of the core wire 110 is substantially bare. In this embodiment, electrical coupling of the core wire 110 is provided upstream of the pretreatment device 130. In one embodiment, the core wire 110 is in communication with the power supply 165 by a roller 555 positioned upstream of the pretreatment device 130. The core wire 110 may be continuously or intermittently fed through the plating tank 135 by a motor 158 coupled to one or more drive roller devices 155A, 155B.

In one embodiment, the core wire 110 is stopped and the power supply 165 is energized to perform a plating process. As the core wire 110 is stopped in the plating fluid 138 and is electrically biased, the fluid 138 enters the openings 210 and diamond particles 180 are plated to the core wire 110 at positions adjacent the openings 210. The applied electrical bias may be continuous for a predetermined period, or cycled based on polarity inversions and/or on a temporal basis until a suitable concentration of fluid 138 has been exposed to the core wire 110. In another embodiment, the core wire is advanced in a continuous mode through the plating fluid 138. In either of these embodiments, diamond particles 180 contained in the plating fluid 138 are coupled to the core wire 110 at selected locations. Thus, a predetermined pattern of diamond particles 180 is formed on the core wire 110.

After the plated wire 170 is removed from the plating tank 135, the plated wire 170 is advanced through the post-treatment device 140 and to the take-up roll 145. In this embodiment, the post-treatment device 140 may be configured as a rinse station or include chemistry adapted to remove the remaining dielectric film 520. In one aspect, the remaining dielectric film 520 is removed prior to collection on the take-up roll 145. In another aspect, the remaining dielectric film 520 may not be removed prior to collection on the take-up roll 145. In this embodiment, the remaining dielectric film 520 may be utilized during a cutting process to enhance cutting and/or allowed to wear away during the cutting process.

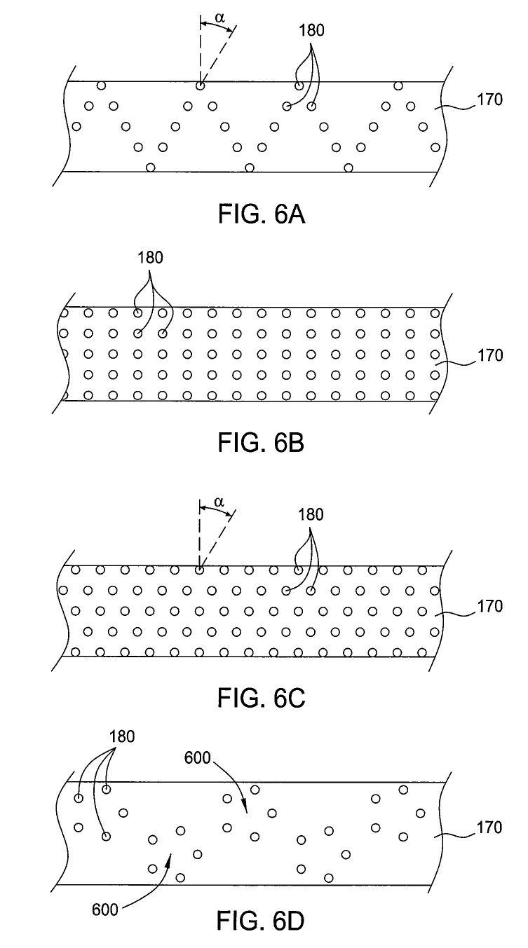

FIGS. 6A-6D are side views of a portion of a plated wire 170 showing embodiments of patterns of diamond particles 180 coupled to the core wire 110. Plated wire 170 as used herein is intended to refer to a core wire 110 having diamond particles 180 attached thereto and may include coating 175 as described in FIG. 1B as well as the core wire 110 being at least partially bare or including islands of dielectric film 520 as described in FIG. 5B. Thus, the plated wire 170 as used herein includes diamond particles 180 coupled to the core wire having one or a combination of exposed or bare core wire 110 between diamond particles 180, coating 175 between diamond particles 180, and areas of dielectric film 520 between diamond particles 180.

FIG. 6A shows a zig-zag pattern of diamond particles 180. FIG. 6B shows a banded pattern of diamond particles 180. FIG. 6C shows a spiral pattern of diamond particles 180. The pitch and/or angle α of the diamond particles 180 may be varied or uniform based on the desired pattern to be plated on the core wire 110. In one embodiment, each of the diamond particles 180 in FIG. 6B form a screw-pitch or helix pattern similar to threads on a bolt or screw. In one aspect, the pitch between the diamond particles 180 is not uniform or symmetrical with respect to spacing between the diamond particles. However, each row of diamond particles 180 forms a thread-like pattern. In another aspect, the plurality of diamond particles 180 form a double helix pattern that consists of rows of diamond particles 180 spiraling in opposite directions and/or occupying different positions of the core wire 110.

FIG. 6D shows a uniform pattern of clusters 600 that consist of a plurality of diamond particles 180 in a uniform pattern. Each of the clusters 600 may be in a circular shape or a polygonal shape defined by the diamond particles 180. In one embodiment, the clusters 300 are shaped as rectangles, trapezoids, hexagons, pentagons, octagons, and combinations thereof. The pitch and/or spacing on the core wire 110 (linearly or circumferentially) of the clusters 300 may be varied or uniform based on a desired pattern. For example, the clusters 300 may be formed in bands, spirals, a zig-zag pattern as well as other patterns or combinations thereof.

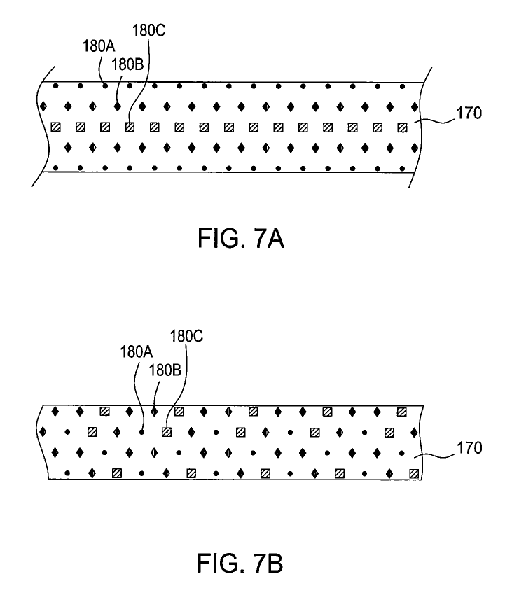

FIGS. 7A and 7B are side views of a portion of a plated wire 170 showing embodiments of patterns of diamond particles 180 formed on the core wire 110. FIG. 7A shows a pattern of diamond particles 180A, 180B and 180C in an arrow-like pattern. FIG. 7B shows a pattern of diamond particles 180A, 180B and 180C in a spiraling arrow-like pattern. In each of these embodiments, the diamond particles 180A, 180B and 180C are different sizes and/or form patterns of multiple diamond particles arranged in a uniform manner on the core wire.

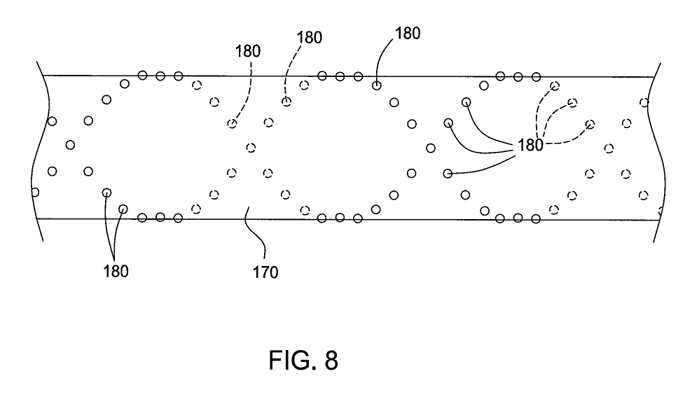

FIG. 8 is a side view of a portion of a plated wire 170 showing another embodiment of a pattern of diamond particles 180 formed on the core wire 110. Some of the diamond particles 180 are shown in phantom as these particles are hidden by the wire 170. In this embodiment, two discrete spirals are shown running in opposite directions and/or occupying different positions along the core wire 170. In other embodiments, rows of spirals which are not shown for clarity may be positioned substantially parallel to the spirals that are shown in FIG. 8. The double helix pattern of diamond particles 180 formed on the plated wire 180 serve to increase cutting accuracy as well as extend lifetime of the plated wire 170.

Embodiments of the plated wire 170 as described herein are utilized to perform a precision cutting process with a higher degree of accuracy. The selection and placement of diamond particles 180 on the core wire 110 prevents the wire from walking off-cut, reduces kerf and/or increases the usable lifetime of the plated wire 170.

While the foregoing is directed to embodiments of the invention, other and further embodiments of the invention may be devised without departing from the basic scope thereof.

What is claimed is:

1. An abrasive coated wire, comprising:
a core wire having a symmetrical pattern of abrasive particles coupled to an outer surface of the core wire; and
a dielectric film covering portions of the core wire between the abrasive particles.

2. The wire of claim 1, wherein the abrasive particles comprise diamond particles.

3. The wire of claim 2, wherein the symmetrical pattern comprises a helix pattern on the core wire.

4. The wire of claim 2, wherein the symmetrical pattern comprises a double helix pattern on the core wire.

5. The wire of claim 4, wherein the double helix pattern comprises a first helix and a second helix disposed on the core wire in opposite directions.

6. The wire of claim 2, wherein the diamond particles are of a substantially uniform size.

7. The wire of claim 2, wherein each of the diamond particles are substantially equally spaced.

8. The wire of claim 1, wherein the abrasive particles comprise a plurality of clusters.

9. The wire of claim 8, wherein each cluster comprises a shape selected from the group of circular, oval, hemispherical, triangular, rectangular, pentagonal, hexagonal, octagonal, a star, and combinations thereof.

10. An abrasive coated wire, comprising:
a core wire made of a metallic material; and
individual diamond particles of a substantially equal size coupled to an outer surface of the metallic material in a symmetrical pattern leaving portions of the metallic material exposed between adjacent diamond particles.

11. The wire of claim 10, wherein the symmetrical pattern comprises a helix pattern.

12. The wire of claim 10, wherein the symmetrical pattern comprises a double helix pattern.

13. The wire of claim 12, wherein the double helix pattern comprises a first helix and a second helix disposed on the core wire in opposite directions.

14. The wire of claim 10, wherein each of the diamond particles are substantially equally spaced.

15. The wire of claim 10, wherein the diamond particles comprise a plurality of clusters.

16. The wire of claim 15, wherein each cluster comprises a shape selected from the group of circular, oval, hemispherical, triangular, rectangular, pentagonal, hexagonal, octagonal, and a star pattern.

17. An abrasive coated wire, comprising:
a core wire having a helical pattern of individual diamond particles coupled to an outer surface of the core wire, the diamond particles being a substantially equal size.

18. The wire of claim 17, wherein the core wire comprises a metallic material and portions of the metallic material between individual diamond particles is exposed.

19. The wire of claim 17, wherein the helical pattern comprises a double helix pattern.

20. The wire of claim 19, wherein the double helix pattern comprises a first helix and a second helix disposed on the core wire in opposite directions.
